(19) United States
(12) Patent Application Publication
(10) Pub. No.: US 2011/0108424 A1
(43) Pub. Date: May 12, 2011

(54) DEVICE FOR SEPARATING BIOMOLECULES FROM A FLUID

(75) Inventors: Pierre Puget, Saint Ismier (FR); Florence Ricoul, Quaix-en-Chartreuse (FR)

(73) Assignee: COMMISSARIAT A L'ENERGIE ATOMIQUE ET AUX ENERGIES ALTERNATIVES, PARIS (FR)

(21) Appl. No.: 12/991,548

(22) PCT Filed: May 5, 2009
(86) PCT No.: PCT/FR09/00531

§ 371 Date: Dec. 6, 2010

(30) Foreign Application Priority Data
May 6, 2008 (FR) 08/02523

(51) Int. Cl. C25B 7/00; B82Y 99/00

(52) U.S. Cl. 204/601; 977/742; 977/762

(57) ABSTRACT

The device for separating biomolecules from a fluid comprises a microfluidic component provided with at least one microchannel having at least one of the walls supporting a plurality of nanotubes or nanowires. The component comprises at least one electrode electrically connected to at least a part of the nanotubes or nanowires and the device comprises means for applying a voltage between the electrode and the fluid. The nanotubes or nanowires are divided into several active areas in which the nanotubes or nanowires have a different density.

### BACKGROUND OF THE INVENTION

The invention relates to a device for separating biomolecules from a fluid comprising a microfluidic component provided with at least one microchannel having at least one of the walls supporting a plurality of nanotubes or nanowires, said component comprising at least one electrode electrically connected to at least a part of the nanotubes or nanowires, the device comprising means for applying a voltage between the electrode and the fluid.

### STATE OF THE ART

Microsystems of lab-on-a-chip type exist for performing analyses and/or operations on chemical or biological samples of small size. Due to continuous miniaturization, micro and nanoelectronics technologies are enabling more and more functions to be integrated in a single microfluidic component. These functions conventionally consist in pre-processing the sample, filtering it, separating it, detecting it, etc.

Recent developments have enabled the use of carbon nanotubes. international patent application WO-A-2006/122697 thus describes a microfluidic component, illustrated in FIG. 1, comprising at least one channel enabling a fluid to flow. Channel 1 is preferably a closed channel, i.e. it comprises an inlet and an outlet of the fluid and it is delineated by a bottom wall 2, two opposite side walls 3a and 3b facing one another and a top wail 4. Bottom wall 2 and side walls 3a and 3b are made in a support, preferably a silicon substrate, and top wall 4 can be formed by a cover preferably sealed to the substrate. At least one of walls 2, 3a, 3b supports a plurality of nanotubes 9. Making horizontal nanotubes (parallel to bottom wall 2) in the channel enables a fluidic component presenting an increased processing surface to be obtained.

International patent application WO 01/63273 describes a device (FIG. 2) comprising a microfluidic component provided with a microchannel delineated by a bottom wall 2 and two side walls 3a and 3b, Microchannel supports a plurality of carbon nanotubes 9 on its bottom wall 2. Each end of microchannel 1 comprises a reservoir 5a, 5b designed to receive a fluid comprising charged molecules 6. Reservoirs 5a and 5b, placed at each end of microchannel 1, respectively comprise a negative terminal 7 and a positive terminal 8 enabling an electric field with a vector E to be created along microchannel 1. The electric field enables the negatively charged molecules present in the reservoir of negative terminal 7 to move in the direction of the reservoir of positive terminal 8 by electrophoresis. The nanotubes of the microchannel then form a molecular sieve the spacing of the nanotubes whereof is adjusted according to a type of molecule. Such a device requires different sieve densities to be produced. Furthermore, in certain cases, molecules, in particular DNA molecules, can be wrapped around the nanotubes forming traps that are difficult to clean.

Patent application US-2004/0173506 describes the use of nanofibers to form a membrane and to control transport of molecules. The distance separating two nanofibers being representative of the maximum size of the molecules able to pass through the membrane.

Patent application US2007/0090026 describes production of two-dimensional sieve structures by conventional microelectronics techniques to improve the speed and resolution of biomolecule separation. The sieve structures are produced by etching in a silicon substrate by means of photolithography and reactive ion etching (RIE) techniques, which enables controlled topography to be obtained with submicronic precision. The flat sieve structures comprise parallel main channels with a width of 1 μm and a depth of 300 nm connected to one another by lateral channels with a width of 1 μm and a depth of 55 nm. Molecules, such as DNA and protein molecules, can pass from a first main channel to a second main channel via the lateral channels connecting the adjacent first and second main channels. The surfaces of the device can be negatively charged. The weakly negatively charged molecules can thus pass from one main channel to the other with a better probability than the strongly negatively charged molecules.

The separation devices currently proposed in the different studies to separate biological molecules present the major drawback of being difficult to industrialize, as they are costly to fabricate. They do in fact require lithography steps which prove very costly to produce pores or channels of a dimension corresponding to the size of a molecule concerned.

### OBJECT OF THE INVENTION

The object of the invention is to provide a device for separating biomolecules from a fluid that does not present the drawbacks of the prior art.

This object is achieved by the appended claims and more particularly by the fact that the nanotubes or nanowires are divided into several active areas in which the nanotubes or nanowires have a different density.

According to an improvement, the density of nanotubes or nanowires of the active areas increases from one area to the next in the direction of flow of the fluid.

According to an improvement, each area is connected to distinct electrodes, the device comprising means for applying different voltages to the different electrodes.

### BRIEF DESCRIPTION OF THE DRAWINGS

Other advantages and features will become more clearly apparent from the following description of particular embodiments of the invention given for non-restrictive example purposes only and represented in the appended drawings, in which:

FIG. 1 illustrates a cross-sectional view of a microfluidic component according to the prior art.

FIG. 2 illustrates a perspective view of a device for separating biomolecules by electrophoresis according to the prior art.

FIG. 3 illustrates a top view of a device according to the invention.

FIG. 4 illustrates a cross-sectional view along A-A of FIG. 3.

FIG. 5 illustrates a top view of the device of FIG. 3, the cover of the device having been removed,

FIGS. 6 to 8 illustrate the interactions of the nanotubes of the device according to the invention with charged or uncharged particles.

FIGS. 9 and 10 illustrate variants of an embodiment of the invention in top view without the cover.

FIG. 11 illustrates a second embodiment in top view without the cover.

FIG. 12 illustrates a variant of the second embodiment in top view without the cover.

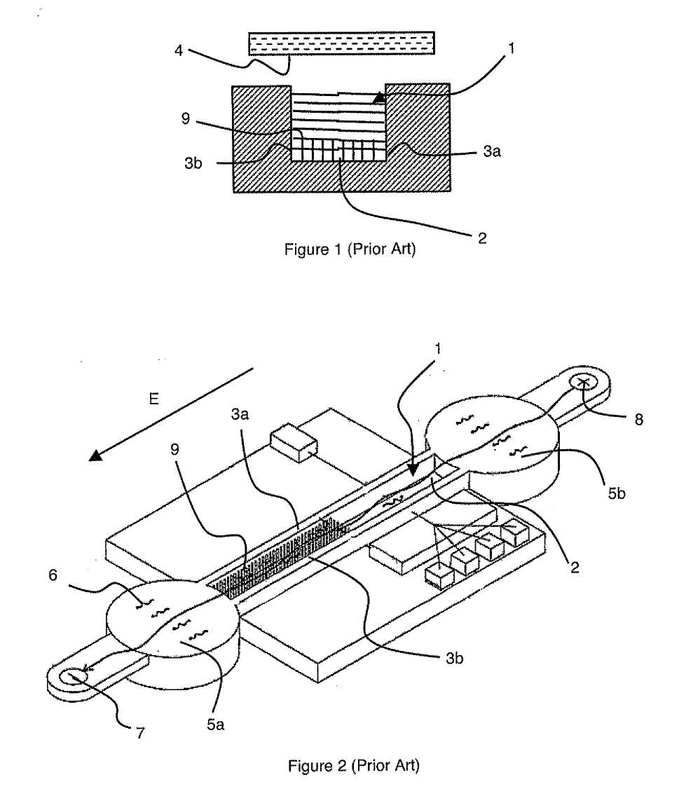

### DESCRIPTION OF PARTICULAR EMBODIMENTS

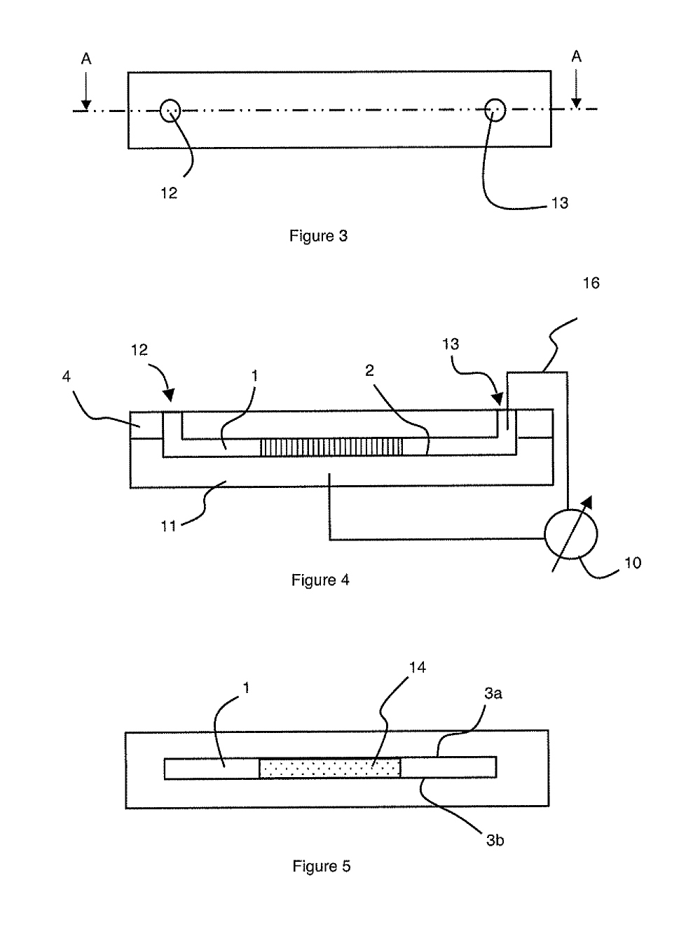

According to a particular embodiment illustrated in FIGS. 3 to 5, the device for separating biomolecules from a fluid comprises a microfluidic component provided with at least one microchannel 1 delineated by a bottom wall 2 and two side walls 3a and 3b facing one another. Microchannel 1 is preferably a closed microchannel (FIG. 4) and is delineated by a top wall 4 which comprises an inlet 12 and an outlet 13 for passage of the fluid.

The fluid can be made to flow in the separating device by applying for example a pressure difference between inlet 12 and outlet 13 of the device. This pressure difference can for example be applied by using a syringe pusher, a peristaltic pump or any other means known to the person skilled in the art. The microchannel represented in FIGS. 3 to 5 is of straight shape but it may also be in the form of a curve, a spiral, a circle, etc.

The microfluidic component can thus be produced in a substrate in which the microchannel is burrowed to form bottom wall 2 and side walls 3a and 3b. Top wall 4 can be formed by a protective cover, preferably hermetically sealed so as to obtain a closed and completely tight microchannel 1. The substrate can for example be made from silicon. The device further comprises means 10 for applying an electric voltage between an electrode 11 of the microfluidic component and the fluid. Electrode 11 can be formed on a part of the microchannel by local doping of the silicon substrate or by using a fully doped substrate.

At least one of microchannel walls 2, 3a, 3b supports a plurality of electrically conducting nanotubes 9 or nanowires forming an array. Nanotubes 9 are preferably perpendicular to the wall or walls that support the latter. Electrode 11 of the fluidic component is electrically connected to at least a part of nanotubes 9. if electrode 11 is formed by the doped substrate, all the nanotubes are automatically connected to the electrode. A DC voltage V, preferably adjustable, is applied between electrode 11 and the fluid by means 10 for applying voltage. In the particular embodiment illustrated in FIG. 4, a voltage source is connected to the substrate which forms electrode 11, and to the fluid by means of fluid outlet 13.

Nanotubes 9 can for example be made from carbon. Carbon presents the advantage of being conductive. By making the surface potential of the nanotubes vary, the surface of the nanotube thereby enables the amplitude of the electrostatic interaction of each nanotube 9 to be modulated. The fluid filling the microchannel is preferably an electrolyte (aqueous solution containing positive and negative ions), other polar solvent-base fluids being conceivable. When an electric potential V is applied between the nanotubes and the fluid filling the microchannel, according to the sign of the electric potential V, the nanotubes surround themselves with a cloud of counter-ions thereby creating a non-homogeneous distribution of the electric charges and of the local electric fields. The distribution of these counter-ions is known under the term of double electrostatic layer (here around a cylinder). The electric potential is equal to V at the surface of the nanotube and decreases asymptotically to the potential of the fluid. The equipotential surfaces have a cylindrical geometry centered around the nanotube. The characteristic length of the potential decrease is called the Debye length. The Debye length does not depend on the electrostatic potential but on the ion concentration of the fluid or buffer solution filling the microchannel, this concentration also being commonly called “ionic strength” of the buffer. When the distance separating the nanotubes is about the Debye length or less, the array of nanotubes forms an electrostatic barrier defined by equipotential lines and electric field lines perpendicular to the equipotential lines. Thus, when charged particles or molecules approach the nanotubes to which an electric potential has been applied, i.e. that are electrostatically charged, the particles or molecules having a charge of the same sign as that of the nanotubes tend to be repelled.

The phenomenon enabling the molecules to be separated according to their charge is based on the hydrodynamic diameter of the molecules. The hydrodynamic diameter (also noted Dh) corresponds to the dimension (or diameter) of the molecule proper added to twice the Debye length, noted λ_{D}. The Debye length corresponds to the thickness of the double electric layer surrounding the molecule when the latter is charged. The Debye length corresponds in particular to the thickness of a cloud of counter-ions locally balancing the charge of the molecule when the latter is charged and contained in a fluid. It depends on the conditions of the fluid comprising the molecule(s), in particular on the type and concentration of electrolyte(s) present and on the temperature.

Separation of the molecules contained in the fluid is performed by the barriers constituted by the nanotube array, more particularly by the passages delineated by two adjacent nanotubes. A nanotube barrier is preferably perpendicular to the direction of flow of the fluid in the microchannel, the nanotubes being supported either by bottom wall 2 or by side walls 3a and 3b. According to an alternative embodiment, the nanotubes can be supported by top wall 4 forming the cover.

The nanotubes forming the barrier preferably occupy a whole section of the microchannel so as to form an alignment of nanotubes over the whole of the section.

The passage delineated by two adjacent nanotubes 9 corresponds to the real distance dᵣ. Thus, as illustrated in FIG. 7, the small uncharged molecules PM having a diameter of less than dᵣ can pass between two adjacent nanotubes, unlike the large uncharged molecules GM which remain restrained.

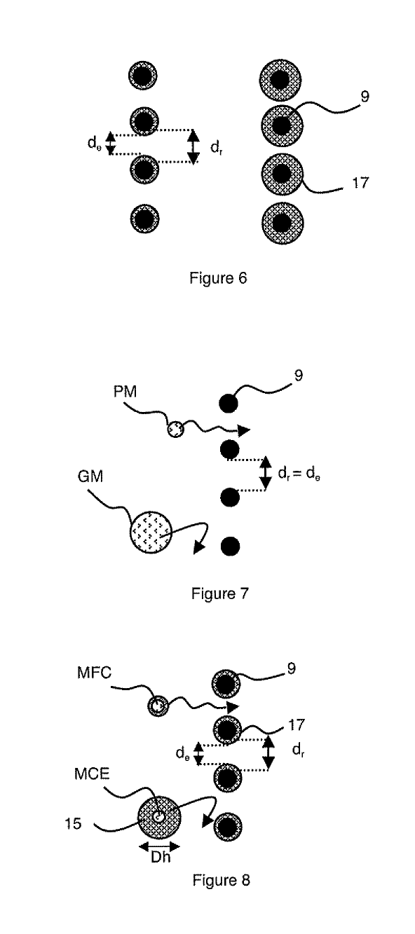

Application of a voltage V between the nanotubes and the fluid filling the microchannel enables a controllable effective distance dₑ to be obtained between two adjacent nanotubes, as illustrated in FIGS. 6 and 8. The effective distance is defined by the following formulas:
dₑ=dᵣ−2λ_{D}, where dᵣ corresponds to the distance separating two adjacent nanotubes and λ_{D} corresponds to the Debye length, when the array of nanotubes and the molecule are electrostatically charged by charges of the same sign,
dₑ=dᵣ, in the other cases, in particular when the array of nanotubes and the molecule are of opposite signs or when they are not charged as described in the foregoing with reference to FIG. 7.

Thus, as illustrated in FIG. 8, the effective distance dₑ between the nanotubes is chosen such as to only let the required type of molecule pass and it is more particularly chosen according to the hydrodynamic diameter Oh of the molecules to be separated. Molecules of substantially similar sizes can thus be separated according to their charges, as illustrated by FIG. 8.

The weakly charged molecules MFC (small cloud of counter-ions 15) can pass through the barrier of nanotubes 9, whereas the strongly charged molecules MCE (large cloud of counter-ions 15) cannot pass the barrier.

For example purposes, a positively-charged nanotube array can restrain positively-charged molecules if the effective distance dₑ between two adjacent nanotubes is smaller than the hydrodynamic diameter of the molecule. If on the other hand the nanotube array and the molecule are charged by charges of opposite signs, it suffices for the hydrodynamic diameter of the molecule to be larger than the real distance dᵣ separating two adjacent nanotubes of the nanotube array.

Means 10 for applying voltage enable the applied voltage to be modified in order to charge the nanotubes electrostatically and in controlled manner, which enables the probability of a molecule passing through to be increased or decreased. FIG. 6 represents two rows of nanotubes 9 with different electric potentials 17. With nanotubes of the same diameter, the range of the electrostatic interactions of carbon nanotubes 9 can be modulated.

The electrostatic charge of the molecules contained in the fluid further depends on the pH of the solution constituting the fluid. It is thus possible to adjust the pH of the solution according to the charge required for the molecules, which also enables passage of the molecules to be increased or decreased. The molecules concerned are very often nucleic acids or proteins (assembly of amino-acids) forming weak negatively-ionized acids in certain PH ranges. The fluid used as buffer solution containing these molecules can then be a solution which is more or less charged with salt. The charged molecules then surround themselves with a cloud of counter-ions having a diameter that can range from a few nanometers to several tens of nanometers depending on the concentration and composition of the salts.

The use of electrically conducting nanotubes 9 connected to electrode 11 enables the electric potential of nanotubes 9 to be controlled actively (in real time). These nanotubes 9 are separated by a few nanometers, a distance of 10 nm being able to be envisaged. The distance separating two adjacent nanotubes is preferably comprised between 1 and 20 nm. Thus, when an electric voltage is applied thereto, they can form an electrostatic barrier for the charged molecules having a charge of the same sign as that of the nanotubes. By modifying the voltage between the fluid and the nanotubes, it is possible to modulate the electric potential of the nanotubes, thereby modulating the permeability of the electrostatic barrier.

Such a device both acts as a sieve according to the distance between the nanotubes and/or enables molecules of different charges to be retained or to be allowed to pass.

Such a device can thus act as a filtration and separation system of the molecules, but it can also act as a system enabling the molecules to be concentrated. In the latter case, the molecules of interest simply have to be retained in front of a section of nanotubes forming an electrostatic barrier, while at the same time eluting the smaller molecules. Then, once the retention area situated to the front of the barrier has been enriched with molecules of interest, the electric voltage applied to the barrier is released enabling the molecules of interest to pass and an eluate highly enriched in molecules of interest to be collected.

Production of the microfluidic component described in the foregoing can use the method described in patent application WO-A-2006/122697, from a doped silicon substrate with a resistivity of preferably 0.01 Ω·cm.

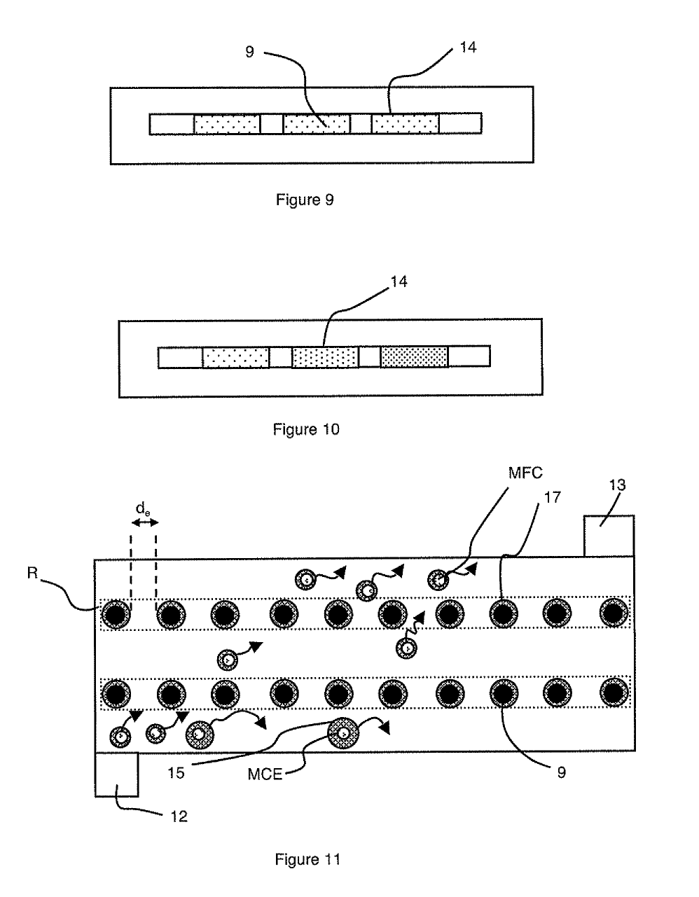

According to an alternative embodiment illustrated in FIG. 9, nanotubes 9 are divided into several active areas 14 in which the density of nanotubes is similar. Nanotubes 9 of each active area 14 are electrically connected to a distinct corresponding electrode (not shown). The device thus comprises means for applying different voltages to the different electrodes of the microfluidic component. Such a device, with distinct electric addressing for each electrode, enables a different electric potential to be obtained at the level of the nanotubes of each active area 14. The effective distance dₑ separating two adjacent nanotubes can thus be modified differently, in real time, in each active area 14. In a preferred embodiment, this effective distance dₑ can decrease gradually from the first area to the last area, resulting in a gradual separation of the molecules from one area to the other. It is thus possible to isolate different types of molecules with a single device.

According to another alternative embodiment illustrated in FIG. 10, the density of nanotubes is different in the different active areas 14. For example, the density of nanotubes increases from area to area according to the direction of flow of the molecules contained in the fluid (from left to right in FIG. 10). The electrically conductive nanotubes can all be connected to a single electrode (not shown), connected to means for applying a voltage between the electrode and the fluid. The nanotubes thus have the same electric potential and separation of the biomolecules contained in the fluid takes place gradually according to the density of nanotubes and the electric potential of the active areas 14 through which the fluid passes.

in an alternative embodiment of FIG. 10, the nanotubes of each active area are electrically connected to distinct electrodes. The device then comprises means for applying different and variable voltages for each electrode. Such a device, with distinct electric addressing for each electrode, enables a different electric potential to be obtained at the level of the nanotubes of each area resulting in gradual separation of the molecules from one area to the other molecules which is modifiable in real time.

A variation of the density of nanotubes and/or of the voltage applied between the nanotubes and the fluid can thus be used to define the effective distance separating two adjacent nanotubes, and consequently the size and/or charge of the molecules respectively liable to pass through a barrier formed by these nanotubes or to be restrained by this barrier.

To produce a device comprising a microchannel provided with several active areas, the method described in International patent application WO-A-2006/122697 can be modified by using a locally doped silicon substrate to form different electrodes, each electrode then forming an active area 14 on which the nanotubes are formed.

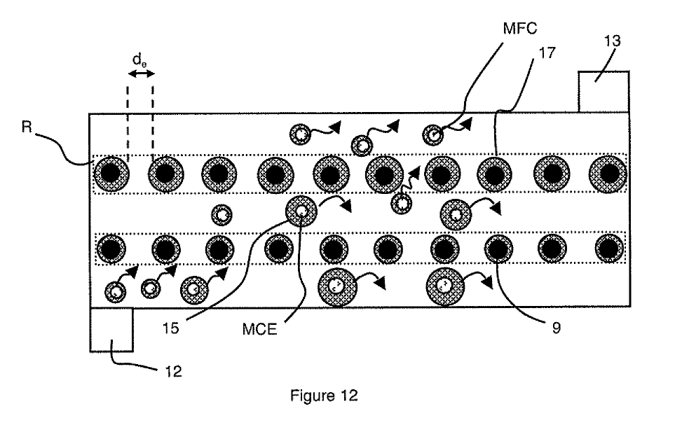

According to another embodiment illustrated in FIG. 11, nanotubes 9 can be in the form of rows R (in dotted lines in FIG. 11) separating two adjacent nanochannels and forming barriers arranged slightly obliquely with respect to the direction of flow of the fluid. The distance separating two rows of nanotubes 9 is greater than the distance separating two adjacent nanotubes of the same row. In the particular embodiment represented in FIGS. 11 and 12, the general direction of flow of the fluid is controlled for the rows of s nanotubes to be placed obliquely with respect to this direction. In FIGS. 11 and 12 for example, fluid inlet 12 and outlet 13 are respectively situated in the bottom left part and the top right part, and the fluid is inserted under pressure between inlet 12 and outlet 13, i.e. obliquely with respect to rows R of nanotubes. Only molecules MFC having a smaller hydrodynamic diameter than the effective distance dₑ separating the nanotubes of the same row can pass the barrier formed by these nanotubes and their electric potential 17 and thereby pass into the top nanochannel of FIGS. 11 and 12. Thus in FIG. 11, molecules MCE having a larger hydrodynamic diameter than the effective distance are restrained in the bottom nanochannel, whereas molecules MFC can pass into the top nanochannel. The molecules can thus be sorted according to their sizes and/or charges, two adjacent nanochannels comprising molecules of different size and/or charge at their end located near outlet 13.

According to an alternative embodiment illustrated in FIG. 12, a different electric potential 17, preferably increasing from bottom to top, is applied to each row R of nanotubes 9 thereby enabling molecules of different size and/or charge to be separated. Thus, in FIG. 12, molecules MCE having a hydrodynamic diameter that is smaller than the effective distance of the bottom row but larger than the effective distance dₑ of the top row of nanotubes are restrained in the center nanochannel, whereas molecules MFC can pass into the top nanochannel and other molecules having a hydrodynamic diameter that is greater than the effective distance of the bottom row of nanotubes remain in the bottom nanochannel. The rows can also have a different spacing between the nanotubes so as to act on both, the size and charge factors of the molecules.

The means for applying voltage 10 can comprise a platinum wire 16 (FIG. 4) dipped in the fluid, or any other means able to be adapted by the person skilled in the art.

The embodiments described above enable the molecules of a mixture of arbitrary complexity to be separated, such as a mixture of nucleic acids, and/or a mixture of proteins and/or a mixture of peptides for example. This separation can be performed continuously by modifying the electric voltage applied to the nanotubes in real time.

Furthermore, application of a voltage between the fluid and the nanotubes makes cleaning of the device easier in particular when the DNA molecules are wrapped around the nanotubes, application of an electric potential on the nanotubes enabling the wrapped molecules to be removed.

The device can contain a plurality of microchannels enabling processing of the molecules in parallel.

The invention is not limited to the embodiments described in the foregoing, in particular the nanotubes can be replaced by electrically conductive nanowires, preferably made from doped silicon.

1-7. (canceled)

8. Device for separating biomolecules from a fluid comprising a microfluidic component provided with at least one microchannel having at least one wall supporting a plurality of nanotubes or nanowires, said component comprising at least one electrode electrically connected to at least a part of the nanotubes or nanowires and the device comprising means for applying a voltage between the electrode and the fluid, device wherein the nanotubes or nanowires are divided into several active areas in which the nanotubes or nanowires have a different density.

9. Device according to claim 8, wherein the density of each area increases from one area to the next in the direction of flow of the fluid.

10. Device according to claim 8, wherein each area is connected to distinct electrodes, and the device comprises means for applying different voltages to the different electrodes.

11. Device according to claim 8, wherein the nanotubes or nanowires form perpendicular barriers to the direction of flow of the fluid in the microchannel.

12. Device according to claim 8, wherein the nanotubes or nanowires form oblique barriers with respect to the direction of flow of the fluid in the microchannel.

13. Device according to claim 8, wherein the nanotubes are made from carbon.

14. Device according to claim 8, wherein the nanowires are made from doped silicon.
